(19) United States
(12) Patent Application Publication
(10) Pub. No.: US 2005/0191867 A1
(43) Pub. Date: Sep. 1, 2005

(54) Apparatus for the connection of an electrical or electronic component with at least one electrical connector

(76) Inventors: Gerhard Birkenmaier, Meckenbeuren (DE); Tilo Marschall, Munchen (DE); Thies Hameister, Friedrichshafen (DE); Ralph Bohm, Bodman-Ludwigshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/637,364

(22) Filed: Aug. 8, 2003

(30) Foreign Application Priority Data
Aug. 28, 2002 (DE) 102 39 395.8

(51) Int. Cl. H01R 39/00

(52) U.S. Cl. 439/13

(57) ABSTRACT

An apparatus for the connection of an electrical or an electronic component 1 with at least one electrical conductor 10, 11, 18; 12, 13. In order to accomplish the realization of an electrical connection of the electrical conductor 10, 11, 18; 12, 13 with a component 1, which connection is vibration resistant, economical and of secure mounting characteristics, provision is made that a contacting apparatus is placed on the component 1 which contacting apparatus has at least one axial and radial electrical contact surface 21, 22, 23, which need not be precisely aligned or only roughly aligned, and which is in electrical communication with electric or electronic equipment within the housing 2 of the component, and on which the housing, at each contact surface 21, 22, 23, respectively, at least one electric conductor 10, 11, 18 in regard to interference with the contact point is mechanically permanently and electrically conductively affixed.

### FIELD OF THE INVENTION

The invention concerns an apparatus for the connection of an electrical or an electronic component with at least one electrical conductor.

### BACKGROUND OF THE INVENTION

Control and regulation devices are normally connected with sensors, as well as with switching and activation apparatuses by electrical conductors, in order that an exchange of sensor and control/regulation data may be properly communicated. To this end, as a rule, the electrical conductors possess as a rule, receiving sockets or plugs on their ends which can be respectively connectively joined with complementary plugs or sockets on the equipment or components to be connected. With such connectors, the ends of the electrical conductors of the electrical lines lead, in each instance, to a complementary metallic rod or to a metallic female receiver which completes the circuit.

Connections comprised of only one plug or socket are a matter of common knowledge, wherein the opposite end of the line binds releasably and mechanically directly to a contractor in the other equipment.

The technical requirements of such a plug-in connection are especially difficult to fulfill when said connections are to serve transmission sensors, control or regulation signals of particular importance for the functioning of technical objects. Thus, for example, critical electrical plug-in connections for airbag, motor, or transmission control apparatuses of motor vehicles are often very complex from the standpoint of the technologies of safety. Such complex design is seen as necessary, in order that a fail-safe electrical plug-in contact is established, between the said components and the control and regulation device which may be involved during the entire life of a motor vehicle.

As is taught in particular by DE 200 00 160 U1, electrical contacting apparatuses of this critical type are fastened with the least possible clearances to the wall of controlled transmission equipment in order to assure long lasting and faultless operation. Under certain circumstances, if such a close fitting is not possible, then, by the occurrence of drive line vibrations, the contiguous, movable components of the connection suffer damage. For the achieving of a releasable, vibration free electrical plug-in connection which further can be quickly mounted, proposed in the said DE 200 00 160 U1, a guide shell on the electrical contacting apparatus is provided, among other things. This guide shell would further penetrate the wall of a controller. After making of the desired electrical connection, then a releasable mechanical binding with the housing of the controller is attained by means of a lock within the contacting apparatus.

Electrical contacting apparatuses of this design are comparatively expensive because of the very complex mechanical construction. Further, in the current technical development, the trend is growing to undertake an electronic calibration of coacting, electrical components to assure increased sensibility and functional demands after they are in place, for instance after their electrical connection. By means of this calibration, attached components are made to be precisely tuned, during their individual operational behavior, to the control or regulation devices of the equipment to which they are applied. Since these sensitive components, as a rule, are not provided with any electronic memory storage of their own, then this data for complementary tuning is stored in a central electronic unit. The result of this is that a very close technical signaling connection is established between the electrically connected components which, it is assumed, will remain in working order throughout the entire life of the vehicle, for example.

Thus the present day sensors and control components have now become so reliable that the normal requirement for exchangeability of said sensors and control components, with which separate connectors are now in specific complementary attunement, is being questioned. Among such electronic components which, in the above manner, are so tuned to one another, are pressure controllers such as solenoid valves in the control devices of automatic transmissions.

With this existing background, the purpose of the invention consists of proposing an electrical and mechanical connection which can be simply and securely mounted, and is economical. The connection is to serve between an electronic control and a regulation device as well as between electrical or electronic components such as activators or sensors which first permit an electronic attunement between these components and second enable a vibration resistant electrical connection between the electrical lines to be connected.

### SUMMARY OF THE INVENTION

Accordingly, the apparatus for connecting an electric or electronic component with at least one electrical line is placed on the surface of the housing of the said electric or electronic component and possesses at least one axially and/or radially electrical contacting surface, which stands in electrical or electronic communication with electrical or electronic components within the said component housing. In addition, each of these contacting surfaces can be electrically conductively connected with at least one electric conductor and, at the point of connection, can be permanently affixed by means of mechanical action. Advantageously, the contact surfaces in this arrangement can be placed upon an electrically non-conductive component housing or installed on an electrically, non-conducting surface on the component housing.

In regard to the electrical contact surfaces, it is to an advantage if these are constructed out of metal foil or perhaps are printed circuits and are directly or indirectly connected to the electrical line or lines leading into the component housing.

The electric or electronic component, for example, can be a sender of a measured signal, i.e., a sensor, an electromechanical positioning unit, or an electric and/or electronic actuator. The housing of the said electric or electronic component, for example, can be advantageously designed as a cylinder, as assumed hereafter, although other housing geometries can be employed for the placement of the invented contacting apparatus.

In the case of such a component housing, the contact surfaces are to be found on one of its end facings. If more than one contact surface is involved on the end facing, then the placement of the contact surface(s) can be on a circumferential surface of the component housing. Where such an embodiment of the invention is concerned, at least one of the contact surfaces adjacent to at least one other contact surface can at least be partially radially disposed, whereby an electrical insulation material is provided between the two said contact surfaces for the avoidance, in each case, of a short circuit.

It is possible, however, that on the end face of the component housing, the contact surfaces are strip like and arranged next to one another. This is done, even though one advantage of the invented contractor becomes lost, namely, that advantage wherein only a rough alignment of the end face contact surfaces to those of the to-be-contacted electrical lines is necessary.

Independent of the geometrical design of the contact surfaces on the end face of the component housing, it is advantageous if the contact surfaces are spaced widely from one another when in a radial arrangement. What is achieved by this constructive measure, is, that the points of contact are not on one single, flat surface, and thus the electrical insulation action is improved. In addition to this, in the case of such end-face arrangements, the electrical lines can be affixed more simply to the contact surface than would be the case with axially disposed, non-spaced contact surfaces. Thereby, the danger of a faulty mounting is minimized.

In another development of the invention, in order to increase the number of electrical lines which can possibly be contacted, contact surfaces are installed on the circumferential surface of the component housing and situated radially outward and with an axial spacing therebetween. These contact surfaces can be adjacent to one another or even on opposite sides of the said component housing.

In another embodiment of the invention, provision can be made that the component housing on that end face which is opposite to the end face contact surface, possesses a contractor with which the component can be affixed, either releasably or non-releasably, to another piece of equipment. The connector can then be designed as an axial projection of the component housing and carry a circumferential screw-threading. It is, however, just as possible that the component housing can be adhesively affixed to the housing of another component or soldered or welded permanently thereto.

In another embodiment of the invention, provision can be made that on the contact surfaces of the connection pieces connection pieces for electrical lines can be conductingly releasably and non-releasably installed so that, by means of these connection pieces, the electrical lines are especially easy to attach to the component. The connection pieces themselves are in electrically conducting union with the respective contact surfaces, for example, may be welded, soldered, bonded or affixed by an adhesive so that they are bound mechanically securely to the electrical contact surfaces. In addition to this, the said connection pieces may be so long that these can lead direct to the connection points of a transmission control apparatus, for example.

Additionally in the area of their respective contact surfaces, the connection pieces possess a bend or bridge section (hereinafter, “bridge section”) extending away from the contact surface. This bridge section is equipped with a first contact point which, as seen from the free end of the connection piece, is placed before the said bridge section and is installed in that position to be mechanically secure and electrically conductive. Insofar as a later necessity may call for the removal of such an electrical connection, then this can be accomplished by tearing off or cutting off the connection piece behind the first connection point on the bridge section. With a second connection point behind the bridge section, it is possible that on anotheroron the same contact surface, once again, a mechanically secure and electric conductive connection between the contact surface and the connection piece can be made. Consideration can also be given to the possibility that the connection piece can be shaped to conform to the contour of the component, in order to keep the arrangement and the number of the contact points flexible, for example.

The connection pieces themselves can be installed in the form of free, thin material strips or tracers, or as wires on either a flexible or a very rigid carrier material for electrical circuits (strip tracer boards or fiber circuit boards).

Finally, provision can be made, that at least one of the contact surfaces is interrupted or covered with an insulation layer, in an area, where this one contact surface is not transversed by a connection piece not intended for this one contact surface, or crossed by another non-insulated electrical line.

### BRIEF DESCRIPTION OF THE DRAWINGS

The invention will now be described, by way of example, with reference to the accompanying drawings in which:

FIG. 1 is a schematic profile view of an invented contacting apparatus with axially aligned contact surfaces;

FIG. 2 is an end view of the contacting apparatus in accord with FIG. 1;

FIG. 3 is the contacting apparatus as in FIG. 1, however, in this case with one contact point per connection piece;

FIG. 4 is an end view of the contacting apparatus of FIG. 3;

FIG. 5 is a contacting apparatus with two contact surfaces on end faces and two contact surfaces on the circumferential surface of the component housing;

FIG. 6 is an end view the contacting apparatus of FIG. 5;

FIG. 7 is a contacting apparatus as in FIG. 5, however, in this case with a contact point;

FIG. 8 is an end view of the contacting apparatus in FIG. 7;

FIG. 9 is a contacting apparatus with exclusively radially aligned contact surfaces;

FIG. 10 is an end view of the contacting apparatus in accord with FIG. 9;

FIG. 11 is a contacting apparatus as in FIG. 9, however, in this case with respectively one contact point per connection piece;

FIG. 12 is an end view of the contacting apparatus in accord with FIG. 11;

FIG. 13 is a contacting apparatus as in FIG. 9, however, with a radially opposed alignment of contact surfaces;

FIG. 14 is an end view of the contacting apparatus in accord with FIG. 13;

FIG. 15 is a contacting apparatus as in FIG. 14, but in this case with a contact point;

FIG. 16 is an end view of the contacting apparatus as in FIG. 15;

FIG. 17 is a contacting apparatus with radial and axial aligned contact surfaces;

FIG. 18 is an end view of the contacting apparatus in accord with FIG. 17;

FIG. 19 is the contacting apparatus as in FIG. 17, however, in this case with one contact point; and

FIG. 20 is an end view of the contacting apparatus in accord with FIG. 18.

### DETAILED DESCRIPTION OF THE INVENTION

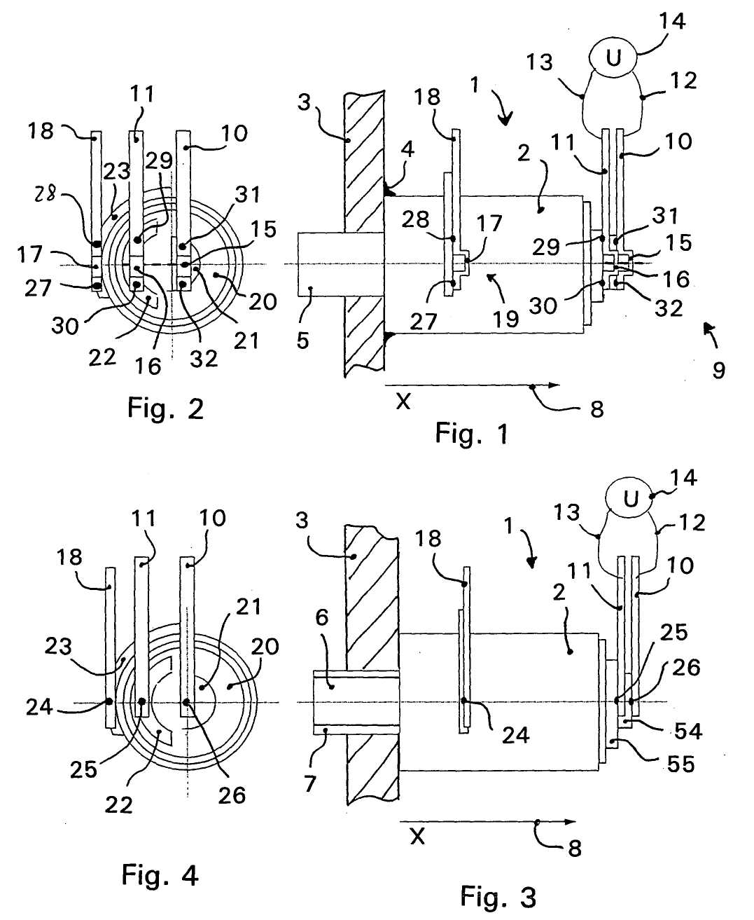

Accordingly, FIG. 1 shows, in a schematic profile view, an electromagnetic component 1, for instance, an electric actuator. This component 1 is equipped with a special embodiment of the invented contact apparatus placed on the surface of its housing 2. By means of this invented contact apparatus, the said component 1 is connected by means of control lines 12 and 13 with another electrical or electronic component 14, for instance, a transmission control device.

In addition, the housing 2 of the component 1 possesses a connector 5, which, penetrating through a boring in a housing wall 3 of another apparatus, can be securely affixed therein.

In the embodiment example of FIG. 1, the contacting apparatus consists, first of one contacting area 9, constructed on the end face of the component housing 2. In this arrangement, at least two axially aligned contact surfaces are placed on the said end face.

Also provided here is at least one central, somewhat circular contact surface 21, as one can clearly see from the end view shown in FIG. 2. This contact surface 21 is, at least partially, encompassed by another annular contact surface 22. As is evident in FIG. 2 in this arrangement, the contact surface 22 can only be installed as a partial segment on an electrically non-conducting carrier material 20. Moreover, on the circumferential shell of the component housing 2, an additional, axially aligned contacting area 19 is to be found, which is constructed here as an annular web. This contacting area 19 carries, in the direction toward the free end of the component housing 2, another contacting area 23.

In addition, FIGS. 1 and 3 show quite clearly that on the free end face of the component housing 2, two axially different projections 54, 55 are constructed, extending in the X-direction (see directional arrow 8). These projections 54, 55 first allow the correct placement of the thereto contacting electrical lines can be made more easily, and second, a larger separating distance between the electrical lines to avoid the occurrence of a short circuit. Beyond this, if at least one of the contact surfaces is in an area, which would be crossed by a connection piece not intended for the said contact surface or crossed by a non-insulated electrical line, then provision can be made that said contact surface is coated over with an insulation layer.

In regard to the contact surfaces, notice should be taken that these consist of an electrical conducting material which, advantageously, is insulatedly carried on the component housing 2 or may be insulatedly secured by an adhesive. In addition, the contact surface material can be comprised of a metallic printed circuit or a more or less thick metal foil, for instance. In addition, one electrically conducting connection, extending from each contact surface, respectively, to the electrical apparatuses within the component housing 2, is to be found.

As may be plainly seen from the clear presentation of FIGS. 3 and 4, connecting pieces 10, 11, 18 are secured on the contact surfaces 21, 22, 23 in an electrically conducting manner and are fastened so that they can only be mechanically separated from the contact surfaces 21, 22, 23 by the application of force. In addition, the connecting pieces 10, 11, 18 are unreleasably, conductively connected with the contact surfaces 21, 22, 23. This connection is carried out in this embodiment example in each case, respectively, at contact points 24, 25, 26. Instead of the connection pieces 10, 11, 18 being connected (as shown) by their free ends to the lines 12, 13 which lead to the control apparatus 14, on the other hand, the lines 12, 13 can also be connected directly onto contact surfaces on the component housing 2.

However, provision can also be made that the connection-side ends of the connection pieces 10, 11, 18, as this is shown in the FIGS. 1 and 2, each exhibit a bridge section, namely, 15, 16 and 17. These bridge sections can be provided with respective electrical contact points. Other arrangements of the connection pieces 10, 11, 18, likewise, can be taken into consideration, such as a connection piece, for example, which is essentially of straight line construction with a preset circuit interruption. This arrangement of the invented contacting apparatus is brought about, so that when a connection piece 10, 11, 18 should be mechanically separated from its respective contact point 27, 30, 32, for the purpose perhaps of testing the electrical component 1 in regard to its capability to function and/or to repair the same, this is respectively done at the connection pieces 10, 11, 18 at the locations of the bridges 15, 16, 17. The renewed electrical contacting and mechanical connection is carried out then, above the bridge section at new contact points 28, 29, 31, without the necessity that new connection pieces or electric components are required.

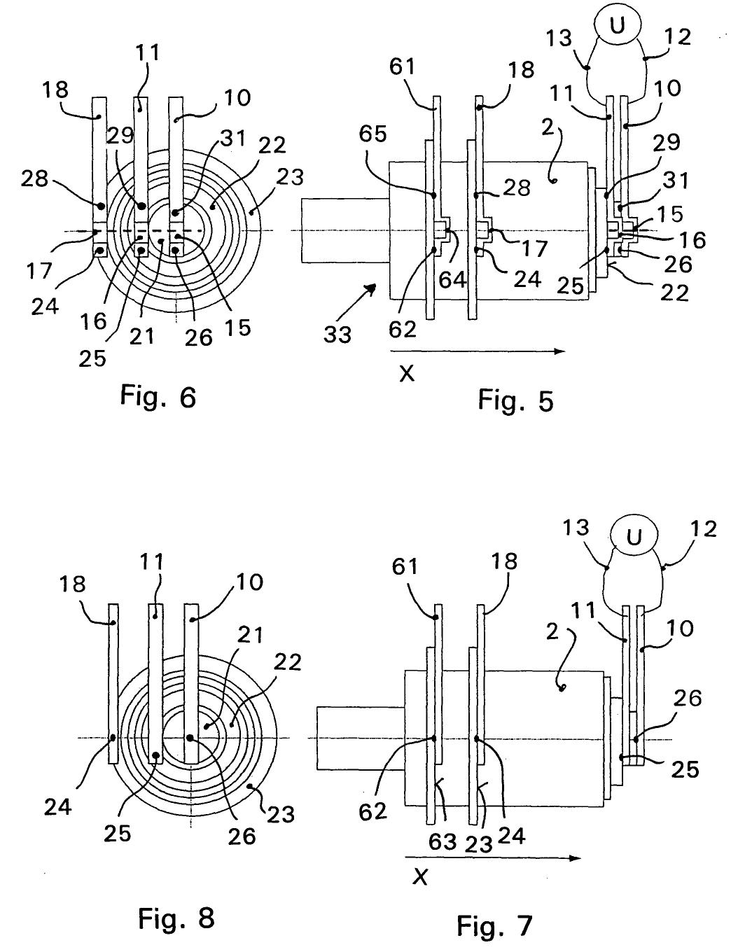

As is demonstrated in FIGS. 5 and 6, the contacting apparatus can also have a fourth as well as a multitude of additional axially, aligned contact areas, this arrangement being denoted by 33, wherein these additional contact areas are advantageously located on the circumferential shell of the component housing 2. This arrangement allows, as will be subsequently carried out in other embodiments of the invented contacting apparatus, that the connection pieces 10, 11, 18, 61 lie flat against the contact surfaces 21, 22, 23, 63 and are individually in electrical communication with these said surfaces through the respective contact points 24, 25 26, 62. (For this arrangement, refer to FIGS. 7, 8.) By making use of connection pieces 10, 11, 18, 61 with the above described bridges, 15, 16, 17, 64, or the angle 37 (FIG. 10), there is, respectively, a second contact point 28, 29 31, 65 which can be employed.

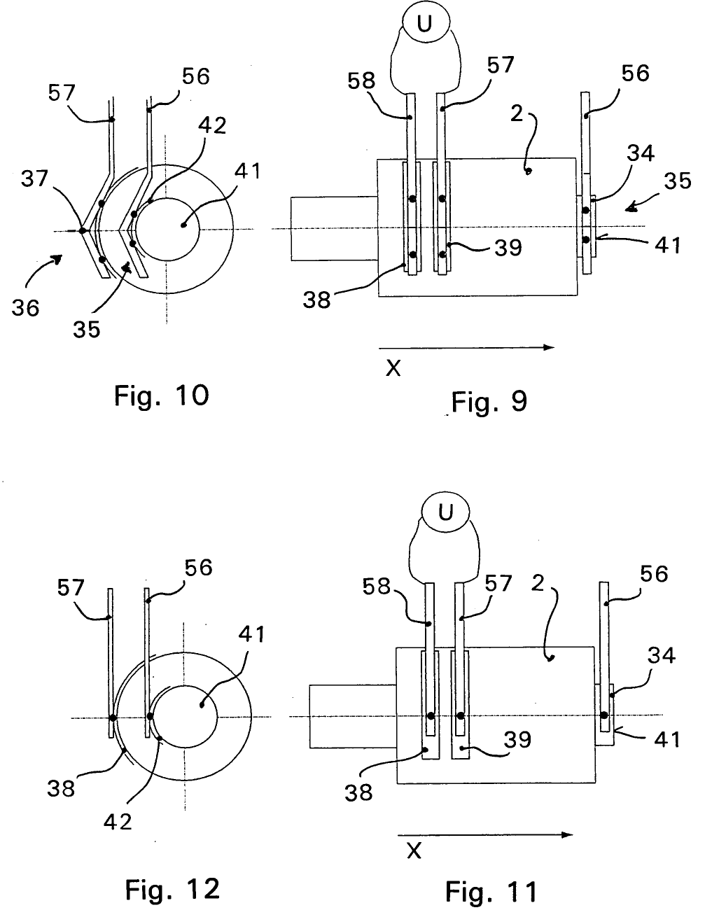

As can be seen in FIGS. 9 to 16, the invented contacting apparatus can also be so designed that all contact surfaces 34, 38, 39 40 43, 53, 60 themselves extend radially outward from the component housing 2. Also, in this instance, connection pieces, which only have one or two contacting areas, can be used. As can be especially inferred from FIG. 10, the possibility also exists of providing connection pieces 56, 57, 58, in the contacting areas 35 and 36 with the angular shape 37 which denote, in electrical conduction, a break-point for a later separation of the connection pieces 56, 57 and 58.

Beyond the above, FIGS. 9 and 10 also show that the component housing 2 can exhibit a comparatively long axial projection 41 in the radial contacting area 35 on the end-face, onto which the radially aligned contact surface 34 is constructed.

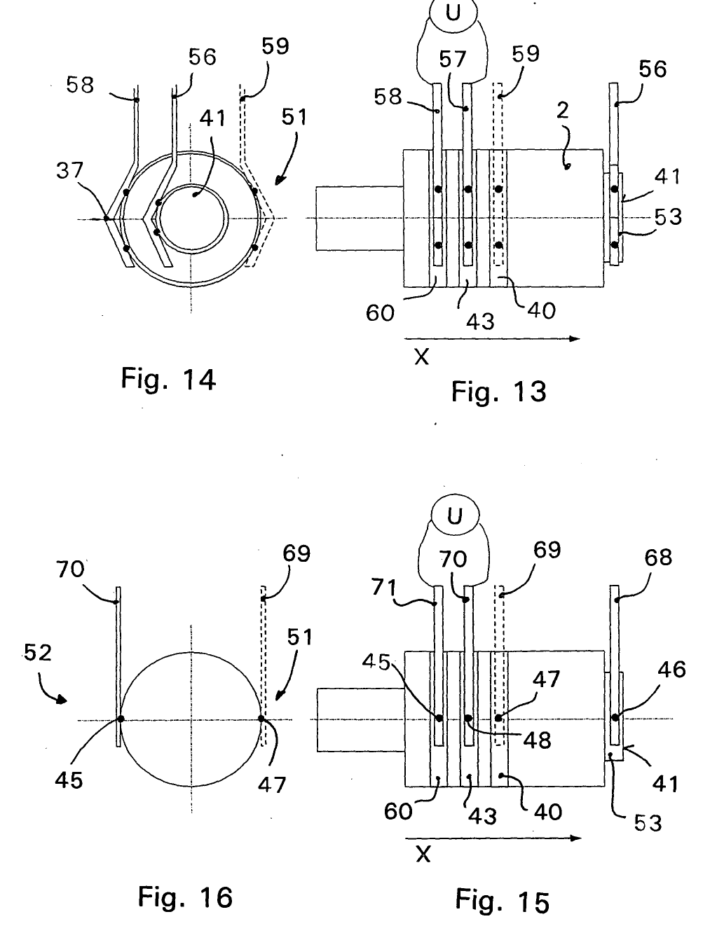

A further embodiment of the invention is demonstrated in FIGS. 13 to 16. As seen here, the contact surfaces 40, 43, 53, 60 themselves extend radially outward as closed rings on the circumferential surface of the component housing 2. While two respective connection pieces, namely, 57, 58, and 70, 71, lie in the central area of the housing 2, closely adjacent to one another, and extend radially in the same direction and are connected with the contact surfaces 43, 60, and an additional connection piece 56, 58 is seated on the contact surface 53 of the axial projection 41, the fourth connection piece 59, 69 on the opposite side (dotted lines) of the component housing 2 is connected by contact surface 40 to a contacting area 51. Also, in this case, the connection pieces 56, 57, 58, 59 are provided with the angles 37, which each provide two contacting possibilities, while in the case of the apparatus in accord with FIG. 15 and FIG. 16 the connection pieces 68, 69, 70, 71 exhibit each only one contact point in the radial contact areas 51, 52, namely, 45, 46, 47 48. Thus, in an advantageous manner, no alignment work is necessary during the mounting process.

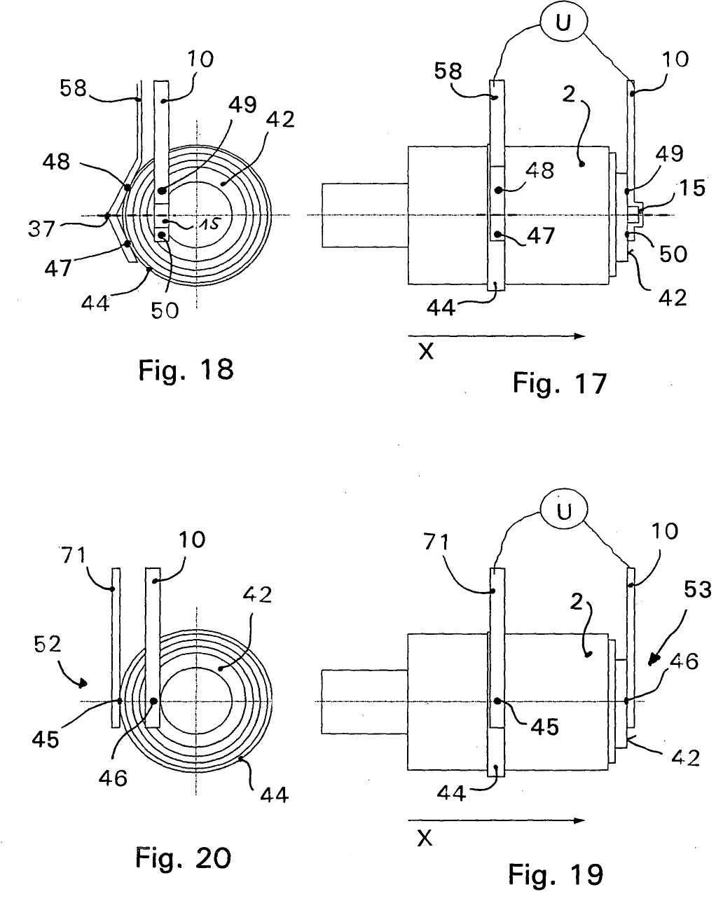

Finally, FIGS. 17 to 20 show further embodiment examples of the invention wherein, respectively, one contact surface is axial and another is radially aligned. Further, in FIGS. 19, 20, connection pieces 10, 71 can be used which only can be connected once by means of a contact point 45, 46 in the contacting area 42, 53 or, as FIGS. 17, 18 indicate, by means of a second contact point 47, 48, 49, 50 with assigned contact surfaces 42, 44. As may also be seen in FIGS. 17, 18, even two different at least mono-contact connection pieces 10 can be installed on one component housing 2 of which, one possesses, for example, the angle 37 and the other, a bridge 15, for instance.

Even in this embodiment example of the invention, the advantage of not requiring an alignment is present during the equipment mounting.

1-18. (canceled)

19. An apparatus for connection of one of an electric and an electronic component (1) with at least one electrical conductor, wherein the apparatus for connection is secured to the component (1) and possesses at least one axial and radially aligned electrical contact surface (21, 22, 23) which is in electrical communication with at least one electric or electronic device in a component housing (2) of the component (1) and wherein each contact surface (21,22,23) is located on an external surface of the component housing (2), and at least one electrical conductor (10, 11, 18) is electrically conductively affixed to at least one contact point (27, 28, 29, 30, 31, 32) of each respective contact surfaces (21, 22, 23) in a matter which by mechanical actions cannot be released.

20. The apparatus according to claim 19, wherein each contact surface (21, 22, 23) is located on one of the external surface of the component housing (2) when the external surface of the component housing (2) is electrically non-conducting and on an electrically non-conducting surface located on the external surface of the component housing (2) when the external surface of the component housing (2) is electrically conducting.

21. The apparatus according to claim 20, wherein the contact surfaces (21, 22, 23) comprise metallic conductors which are connected to electric lines which lead into the component housing (2).

22. The apparatus according to claim 19, wherein the component housing (2) is cylindrically shape and the contact surfaces )21, 22, 23) are located on at least one of: an end face of the component housing (2), and the circumferential surface of the component housing (2).

23. The apparatus according to claim 22, wherein more than one contact surface (21, 22, 23) is located on the end face of the component housing (2), and an electrical insulation material (20) is located between adjacent contact surfaces (21, 22).

24. The apparatus according to claim 23, wherein at least one of the contact surfaces is at least partially encompassed by at least one other contact surface.

25. The apparatus according to claim 23, wherein the contact surfaces on the end face of the component housing (2) located adjacent one another and are strip-like contact surfaces.

26. The apparatus according to claim 23, wherein on the end face of the component housing (2), contact surfaces (21, 22) places radially adjacent one another and the contact surfaces (21, 22) extend various distances in an axial direction (X).

27. The apparatus according to claim 19, wherein contact surfaces (38, 39) are located on the circumferential surface of the component housing (2) which extend radially outward and are spaced from one another.

28. The apparatus according to claim 19, wherein, on diagonally opposite sides of the component housing (2), radially outward extending contact surfaces (43, 60, 40) are located on the circumferential surface of the component housing (2).

29. The apparatus according to claim 19, wherein he component housing (2) has a connection means (5,6) on an end thereof remote from the end face supporting the contact surfaces, which can be affixed to a housing (3) of another apparatus.

30. The apparatus according to claim 19, wherein the connection means (5,6), is constructed as an axial projection of the component housing (2) and a screw threading (7) is formed on he circumferential surface of said connection means (5,6).

31. The apparatus according to claim 19, wherein the connection pieces (10,11, 18) for electric lines (12, 13) are electrically conductively affixed to contact surfaces (21, 22, 23).

32. The apparatus according to claim 31, wherein the connection pieces (10, 11, 18) are electrically conductively and non-releasably affixed to the respective contact surfaces (21, 22, 23) by one of welding soldering bonding and adhesively attaching thereto.

33. The apparatus according to claim 31, wherein a free end of the connection pieces (10, 11, 18) has one of an angle, a bow, and a bend (37) which distances the free end of the connection pieces (10, 11, 18) outward from the respective contact surfaces (21, 22, 23).

34. The apparatus according to claim 31, wherein a free end of the connection pieces (10, 11, 18) have one of a bow and a bridge (15, 16, 17) to enable a mechanical separation of the connection pieces (10,11,18) from the electrical component (1).

35. The apparatus according to claim 33, wherein the contact pieces (10, 11, 18) are mechanically permanently affixed and electrically connected to the contact surfaces (21, 22, 23) by a first contact point (27, 30, 32) before the angle (37) and the piece (10, 11, 18), after a forced breakage or cutting away of the connection piece (10, 11, 18), can have a renewed, mechanically permanent and electrically conductive fix to a second contact point (28, 29, 31) located adjacent the angle (37) on one of another and the same contact surfaces (21, 22, 23).

36. The apparatus according to claim 34, wherein the contact pieces (10, 11, 18) are mechanically permanently affixed and electrically connected to the contact surfaces (21, 22, 23) by a first contact point (27, 30, 32) before the bridge (15, 16, 17) and the connected pieces (10, 11, 18), after a forces breakage or cutting away of the connection piece (10, 11, 18), can have a renewed, mechanically permanent and electrically conductive fix to a second contact point (28, 29, 31) located adjacent the bridge (15, 16, 17) on one of another and the same contact surface (21, 22, 23).

37. The apparatus according to claim 31, wherein the connection pieces (10, 11, 18) are installed on one of a flexible and very rigid carrier material for one of electrical and electronic circuits.

38. The apparatus according to claim 19, wherein at least one of the contact surfaces (21, 22, 23) is to be interrupted or is to be covered by an insulation layer, if found in an area, in which this at least one contact surface is crossed by the contact piece (10, 11, 12) which is not assigned to said contact surface or is crossed by an electrical line without insulation.

39. The apparatus of claim 19, wherein the external surface on which a contact surface is located is one of a circumferential surface of the component housing and an end surface of the component housing.

40. The apparatus according to claim 19, wherein the external surface on which the contact surface is located is one of a circumferential surface of the component housing (2) and an end surface of the component housing (2).

41. The apparatus of claim 39, further comprising:
for each contact surface (21,22,23), a connecting piece (10,11,18) conductively secured to the contact surface and extending outwardly from the component housing in a direction that is one of radially perpendicular to a longitudinal axis of the component housing and tangential to a circumferential surface extending parallel to the longitudinal axis of the component housing.
